(19) United States
(12) Patent Application Publication
(10) Pub. No.: US 2009/0066833 A1
(43) Pub. Date: Mar. 12, 2009

(54) METHOD FOR GENERATING IMAGES AND OPTICAL DEVICE

(75) Inventors: Ivon F. Helwegen, St. Odilienberg (NL); Bernardus H.W. Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,621

(22) PCT Filed: Oct. 28, 2005
(86) PCT No.: PCT/IB2005/053528

§ 371 Date: May 4, 2007

(30) Foreign Application Priority Data
Nov. 10, 2004 (GB) 0424767.2

(51) Int. Cl. H04N 5/232

(52) U.S. Cl. 348/347; 348/E05.042

(57) ABSTRACT

A method for generating a series of images at different zoom angles is disclosed. The method comprises providing an optical device (1) having a liquid-based zoom lens (10) and image recording means (20), recording a first image of an object at a first zoom angle responsive to a user input; and automatically recording a second image of the object at a second zoom angle after recording the first image. The switching speed of a liquid-based zoom lens (10), such as a zoom lens based on electrowetting principles is utilized to automatically generate additional images at different zoom angles, which can be advantageously combined with the image taken by the user of the optical device (1).

The present invention relates to a method for generating a series of images of an object.

The present invention further relates to an optical device comprising a zoom lens and image recording means placed behind the zoom lens.

In the field of image recording, it can be desirable to generate a series of images of an object of interest, for instance to be able to display the object at different scales. However, it is not trivial to obtain such a series, because it is difficult to avoid moving an optical device such as a camera. Furthermore, the object itself may be moving, which makes it even more difficult to generate such a series with sufficient sharpness for each of the images in the series.

The introduction of digital image recording techniques has provided a solution for this problem in the form of digital zoom functionality. With digital zoom, an image can be redimensioned to fit a predetermined area, such as a display screen size or a photographic paper size, by selecting a subset of the complete set of recorded pixels, and fit the spacing of the pixels in the subset to the predetermined area. This is sometimes also referred to as blow-up.

However, digital blow-up has the disadvantage that the image becomes more coarse-grained, which reduces the image quality.

The present invention seeks to provide a method according to the opening paragraph that improves on the prior art.

The present invention further seeks to provide an optical device according to the opening paragraph that improves on the prior art.

According to a first aspect of the present invention, there is provided a method for generating a series of images at different zoom angles, the method comprising providing an optical device having a liquid-based zoom lens and image recording means; recording a first image of an object at a first zoom angle responsive to a user input; and automatically recording a second image of the object at a second zoom angle after recording the first image.

The method is based on the realization that liquid-based zoom lenses, such as the zoom lens disclosed in PCT application WO2004/038480 and the zoom lens disclosed in unpublished PCT application with filing number WO2004/050618, benefit from improved switching speeds compared to mechanically driven solid state zoom lenses. The zoom lenses disclosed in the aforementioned PCT patent applications have a typical switching speed of less than 10 ms for switching between the extremes of the zoom range of the lens. Thus, as soon as a user takes a picture with an optical device comprising such a lens, the optical device can be configured to rapidly take a series of images at different zoom angles, each having the same image quality in terms of pixel density. Also, because the liquid-based lens is very fast, the chance that a user moves the camera during the image capturing process, or the chance that an object moves outside the image range, is reduced.

In an embodiment, the method further comprises combining the first image and the second image into a further image. Thus, the versatility of the generated images can be improved.

Advantageously, the step of combining the first image and the second image into a further image comprises extracting the object from one of the first image and the second image; resealing the extracted object to the dimensions of the object in the other image of the first image and the second image; and replacing the object in the other image with the rescaled extracted object. Consequently, an overview image can be obtained in which the object of interest is of a higher pixel density than its surroundings, yielding an image in which the object of interest is depicted with an improved image quality.

Advantageously, the step of combining the first image and the second image into a further image comprises reducing the size of the first image; and inserting the reduced size first image into the second image. Consequently, an image can be generated including a thumbnail of an overview of the scenery or of an object in close-up.

In an alternative embodiment, the method further comprises automatically recording a third image of the object at a third zoom angle after recording the second image. Thus, a series of images at different zoom angles can be recorded, which for instance enables the user of the optical device to select the best image from the range. This is an important advantage, because it allows the user to generate a first image that only approximates the desired image, with the user relying on the automatic image generation producing the desired image, which means that the user requires less time to prepare the optical device for the image generation. This is particularly useful when the object of interest is moving.

According to another aspect of the invention, there is provided an optical device comprising a liquid-based zoom lens; image recording means placed behind the zoom lens; and control means for automatically generating a second image of an object at a second zoom angle in response to a user controlled generation of a first image of the object at a first zoom angle.

The optical device of the present invention implements the method of the present invention, and therefore benefits from the same advantages.

The invention is described in more detail and by way of non-limiting examples with reference to the accompanying drawings, wherein:

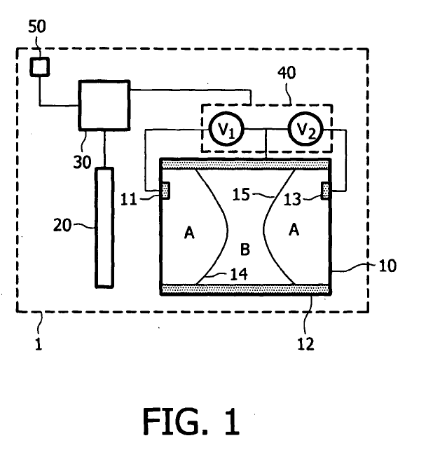

FIG. 1 shows an embodiment of an optical device according to the present invention;

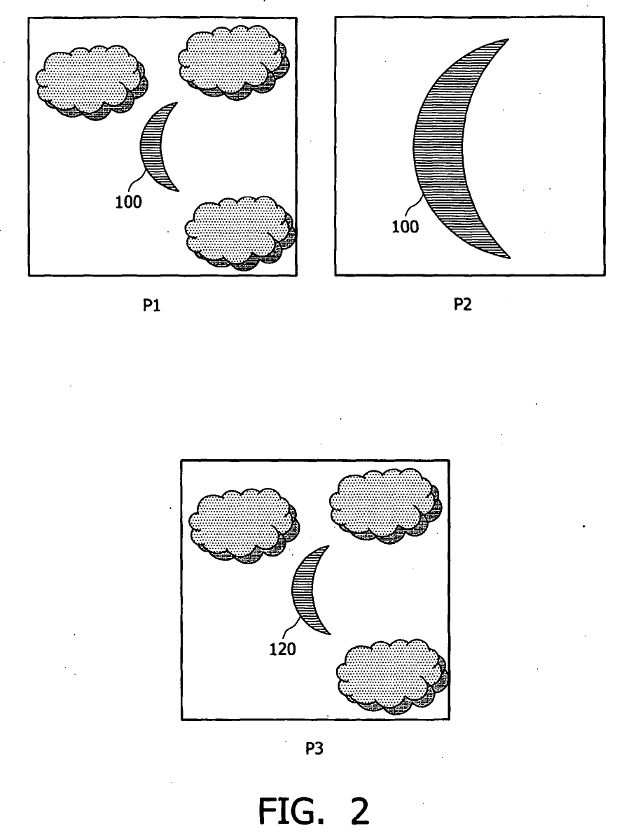

FIG. 2 shows an embodiment of images generated by the method of the present invention;

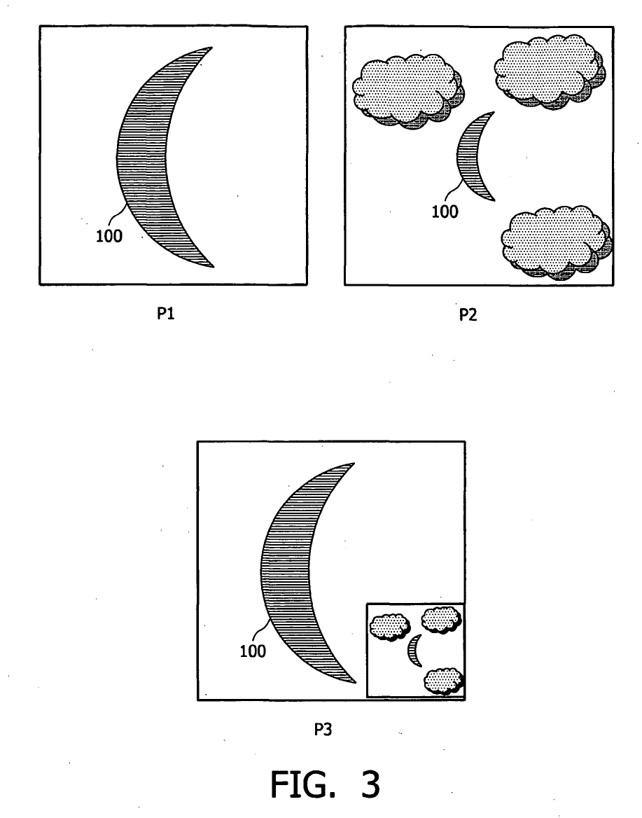

FIG. 3 shows another embodiment of images generated by the method of the present invention; and

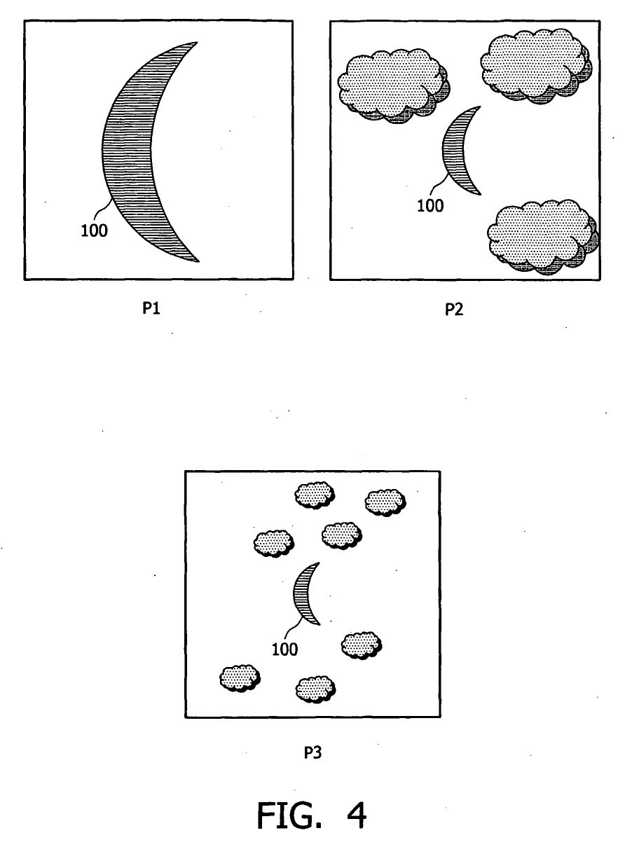

FIG. 4 shows yet another embodiment of images generated by the method of the present invention.

It should be understood that the Figures are merely schematic and are not drawn to scale. It should also be understood that the same reference numerals are used throughout the Figures to indicate the same or similar parts.

In FIG. 1, an optical device 1 according to the present invention is shown. The optical device 1 comprises a liquid based zoom lens 10 placed in front of an image sensor 20. The image sensor 20 is arranged to record am image captured by the zoom lens 10 and produce a corresponding output signal such as an RGB or CMY signal. A processor 30 is arranged to receive and process this output signal. The processor 30 is coupled to driver circuit 40, which is arranged to control the zoom lens 10 in response to instructions from the processor 30. The processor 30 is further coupled to user controlled input 50, which for instance may be a button on the optical device 1 for manual zoom in/out and/or a image capture instruction button. The processor 30 may be a single dedicated processor 30 or a distributed processor 30 comprising a number of subprocessors.

In FIG. 1, the liquid based zoom lens 10 is an embodiment of the electrowetting zoom lens disclosed in PCT application WO2004/038480. The zoom lens 10 comprises two bodies of a first liquid A separated from each other by a second liquid B. Liquids A and B are immiscible, preferably have the same density and have different refractive indices. The first interface 14 defining first contact surface between the first liquid A and the second liquid B and the second interface 15 defining second contact surface between the first liquid A and the second liquid B act as a lens, due to the different refractive indices of the first liquid A and a second liquid B. The inner wall of the optical device 10 comprises an electrode 12, which is separated from the first liquid A and the second layer B by an insulating layer. The insulating layer may be covered by a coating, for instance a parylene layer covered by an AF1600™ coating from DuPont. The coating can be chosen to preferentially attract one of the two liquids, e.g. a hydrophobic coating to attract a hydrophobic liquid. This interaction dominates the shape of the interfaces 14 and 15.

The zoom lens 10 further comprises a first electrode 11 and a second electrode 13 in contact with the first liquid A. The driver circuit 40, which may comprise independently controllable voltage sources V₁ and V₂, is coupled to the wall electrode 12 and the electrodes 11 and 13, thus forming a first electrode pair 11, 12 for controlling the shape of the first interface 14 and a second electrode pair 12, 13 for controlling the shape of the second interface 15. Both the first interface 14 and the second interface 15 can be switched from a stable convex to a stable concave shape in less than 10 ms. The shape change of the first interface 14 and/or the second interface 15 modifies the zoom angle of the zoom lens 10.

In operation, the user of the optical device 1 can use the manual zoom function of the optical device 1 to capture an object 100 in an image. The processor 30 implements the manual zoom function by translating a zoom in/out command from the user into an instruction for the driver circuit 40 to change the shape of at least one of the first interface 14 and the second interface 15. In response, the driver circuit alters the voltage generated by either voltage source V₁ or V₂ or by both voltage sources.

As soon as the user decides to capture an image, e.g. to take a picture, the processor 30 will initiate the image recording process, for instance by activating the image sensor 20 or by opening a shutter (not shown). Thus, a first image of an object 100 at a first zoom angle responsive to a user input is recorded. The processor 30 evaluates the first zoom angle and instructs the driver circuit 40 to move the zoom lens 10 to a second zoom angle, after which the processor 30 will automatically activate the recording a second image of the object 100 at a second zoom angle after recording the first image.

FIG. 2 shows a first example of the method of the present invention. A first image P1 including an object 100 is captured by the user of the optical device 10. The processor 30 evaluates the zoom angle op the zoom lens 10 under which the image P1 is captured. In this particular case, the processor 30 recognizes that the image is taken using a wide angle, which is indicative of a landscape image, and instructs the driver circuit 40 to move the zoom lens 10 to a close-up position. This processor may instruct the driver circuit 40 to alter the zoom angle by a predetermined amount, which may be a function of the first zoom angle. This data may be stored in a memory device such as a look-up table (not shown). Alternatively, the processor 30 may be extended with known object recognition algorithms, and may dynamically calculate the second zoom angle from the first zoom angle and the size of the object 100 recognized in the proximity of the centre of the image P1. As soon as the zoom lens 10 has reached the second zoom angle, the processor 30 triggers the recording of second image P2, with object 100 in close-up. Due to the high switching speed of the liquid based zoom lens 10, this whole process can be completed in less than 20-30 ms, which reduces the risk of the user moving the optical device 1 or an object 100 moving outside the range of the zoom lens 10.

Optionally, the first image P1 and the second image P2 may be combined in the following manner. A known object recognition algorithm may be used to extract the object 100 from the second image P2. The size of the object 100 in the first image P1 is calculated and the extracted object 100 is resized to the dimensions of the object 100 in image P1, after which the object 100 in picture P1 is replaced by the resealed extracted object 120 to form a third image P3. The rescaled extracted object 120 has a higher density of image elements, e.g. pixels, than the original object 100 in image P1, as indicated by the increased density of the horizontal lines in the rescaled extracted object 120 compared to the object 100. Consequently, a further image P1′ is obtained in which the object of interest is described with a higher resolution than in the original image P1.

The resealing of the object 100 may be performed by the processor 30, or may be performed in a post processing step, e.g. by software running on a personal computer. Since such a step can easily be executed by known algorithms, it will not be described in further detail. To facilitate the post-processing, the processor 30 may attach a label to the first image P1 and the second image P2 to indicate an existing relationship between the images.

FIG. 3 shows a second example of the method of the present invention. In this example, the user triggers the recording of a first image P1 with an object 100 in close-up. In analogy with the previous example, the processor 30 evaluates the zoom angle, recognizes that the image P1 is captured in close-up and instructs the driver circuit 40 to move the zoom lens 10 to a wide zoom angle corresponding to a landscape image. The second zoom angle may be a predetermined zoom angle or a dynamically determined zoom angle, as previously explained. Subsequently, the processor 30 initiates the recording of the second image P2 at the second zoom angle, in which object 100 is captured in a landscape mode.

Optionally, the first image P1 and the second image P2 may be combined into a further image P1′, for instance by rescaling the second image P2 to a thumbnail size and inserting the thumbnail into a corner of the first image P1. This may be done by the processor 30 or in a post-processing step, as previously explained.

FIG. 4 shows a third example of the method of the present invention. Upon recording of a first image P1 in response to a user input, the processor 30 can repeatedly instruct the driver circuit 40 to alter the zoom angle of the zoom lens 10 to obtain a second image P2 of the object 100 at a second zoom angle, a third image P3 of the object 100 at a third zoom angle and so on. The first zoom angle may be the initial value of a descending or ascending range of zoom angles or may be an inner value of such a range. The user can rely on this feature by capturing an image of the object 100 that only approximately satisfies the requirements of the user in terms of zoom angle, knowing that the automatic generation of a series of images at different zoom angles is likely to produce the desired image. This reduces the set-up time that the user needs to prepare the optical device 1, which for instance allows the user to capture fast moving objects. The optical device 1 may offer the user the functionality of selecting which of the captured images should be selected. Alternatively, this can be done in a post-processing step with software on a PC.

At this point, it is emphasized that the present invention is not restricted to the embodiment of the liquid based zoom lens 10 shown in FIG. 1. Other liquid based zoom lenses such as the zoom lens disclosed in PCT patent application WO2004/050618, in which the interface between two immiscible liquids is translated along the optical axis through the zoom lens, is equally acceptable. Also, the liquid-based zoom lenses may be combined with solid lenses, e.g. replica lenses without departing from the scope of the present invention. Within the context of the present invention, liquid-based variable focus lenses are intended to fall under the scope of the claims. For instance, it may be advantageous to capture a first image with an object in focus, automatically generate a second image with the surroundings of the object in focus and combine the two images to obtain a resulting image with both the object and its surroundings in focus.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method for generating a series of images (P1, P2) at different zoom angles, the method comprising:
providing an optical device (1) having a liquid-based zoom lens (10) and image recording means (20);
recording a first image (P1) of an object (100) at a first zoom angle responsive to a user input; and
automatically recording a second image (P2) of the object (100) at a second zoom angle after recording the first image.

2. A method as claimed in claim 1, further combining the first image (P1) and the second image (P2) into a further image (P1′).

3. A method as claimed in claim 2, wherein the step of combining the first image (P1) and the second image (P2) into a further image (P1′) comprises:
extracting the object from one of the first image (P1) and the second image (P2);
resealing the extracted object to the dimensions of the object (100) in the other image of the first image (P1) and the second image (P2); and
replacing the object (100) in the other image with the rescaled extracted object (120).

4. A method as claimed in claim 2, wherein the step of combining the first image (P1) and the second image (P2) into a further image (P1′) comprises:
reducing the size of the first image (P1); and
inserting the reduced size first image into the second image (P2).

5. A method as claimed in claim 1, further comprising automatically recording a third image (P3) of the object (100) at a third zoom angle after recording the second image (P2).

6. An optical device (1) comprising:
a liquid-based zoom lens (10);
image recording means (20) placed behind the zoom lens (10); and
control means (30) for automatically generating a second image (P2) of an object (100) at a second zoom angle in response to the user-controlled generation of a first image (P1) of the object (100) at a first zoom angle.

7. An optical device (1) as claimed in claim 6, wherein the control means comprise a processor (30) coupled between the image recording means (20) and a driver circuit (40) responsive to the processor (30), the driver circuit (40) being coupled to the zoom lens (10) for providing the zoom lens (10) with a driving voltage, the processor (30) being arranged to instruct the driver circuit (40) modify the driving voltage after the generation of the first image (P1).

8. An optical device (1) as claimed in claim 6, wherein the control means (30) are further arranged to combine the first image (P1) and the second image (P2) into a further image (P1′).
